(19) United States
(12) Patent Application Publication
(10) Pub. No.: US 2012/0290237 A1
(43) Pub. Date: Nov. 15, 2012

(54) BATTERY CONDITION DETECTING APPARATUS AND BATTERY CONDITION DETECTING METHOD

(76) Inventors: Mitsuhiro Takahashi, Tokyo (JP); Yoshihide Majima, Tokyo (JP)

(21) Appl. No.: 13/519,657

(22) PCT Filed: Jan. 20, 2011
(86) PCT No.: PCT/JP2011/050962

§ 371 Date: Jun. 28, 2012

(30) Foreign Application Priority Data
Feb. 19, 2010 (JP) 2010-035401

(51) Int. Cl. G01N 27/416; G06F 19/00

(52) U.S. Cl. 702/63

(57) ABSTRACT

There is provided a battery condition detecting apparatus including a unit for detecting a secondary battery temperature, a unit for calculating a capacity holding rate of the secondary battery, a unit for detecting a secondary battery voltage, a unit for calculating a waiting time between a time point when a current becomes a predetermined current value or smaller and a time point when a voltage variation per a unit time based on a battery property indicative of a relationship among a temperature of the secondary battery, a capacity holding rate, and the waiting time in response to the temperature detected by the unit and a capacity holding rate calculated by the unit, and a unit for estimating a condition of a residual quantity of the secondary battery based on the voltage detected by the unit after the waiting time calculated by the unit elapses.

### TECHNICAL FIELD

The present invention generally relates to a battery condition detecting apparatus for detecting a condition of a secondary battery, and a battery condition detecting method.

### BACKGROUND ART

As a related art, for example, Patent Document 1 discloses a method of assuming an output voltage continuously being output for a predetermined period of a stable voltage as an open voltage of the secondary battery and estimating a residual quantity of the secondary battery based on a property between the open voltage and the residual quantity. Patent Document 1 discloses that a change of a battery voltage caused due to a change of a battery current shows a predetermined delay, where the battery voltage is stabilized after a predetermined period, which is called a relaxation time. With the method of assuming the output voltage disclosed in Patent Document 1, the relaxation time is considered to have temperature dependence. The length of the period of stable voltage is set in response to a battery temperature.
[Patent Document 1] Japanese Laid-open Patent Publication No. 2007-178215

### DISCLOSURE OF THE INVENTION

### Problems to be Solved by the Invention

FIG. 1 illustrates a voltage stabilizing property of a lithium ion battery. As illustrated in a portion surrounded by a rectangular frame, the output voltage of a secondary battery such as a lithium-ion battery after discharging the secondary battery shows a voltage drop caused by an internal resistance. Thereafter, the output voltage gradually increases for a predetermined period after stopping the discharging current. The inventors of the present application have attempted an experiment. Resultantly, it is found that a time until the output voltage of the secondary battery is stabilized differs depending on a degradation rate of the secondary battery (said differently, a capacity holding rate). Therefore, even if the temperature of the secondary battery is considered as in the above background art, there may be a case where the condition of residual quantity of the secondary battery may not be accurately estimated.

The object of the present invention is to provide a battery condition detecting apparatus which can accurately estimate the condition of residual quantity of the secondary battery.

### Unit for Solving Problems

In order to achieve the above object, the present invention may provide a battery condition detecting apparatus including a temperature detecting unit configured to detect a temperature of a secondary battery; a capacity holding rate calculating unit configured to calculate a capacity holding rate of the secondary battery; a voltage detecting unit configured to detect a voltage of the secondary battery; a waiting time calculating unit configured to calculate a waiting time between a time point when a current of the secondary battery becomes a predetermined current value or smaller and a time point when a voltage variation of the secondary battery per a unit time based on a battery property of the secondary battery indicative of a relationship among a temperature of the secondary battery, a capacity holding rate of the secondary battery, and the waiting time in response to the temperature detected by the temperature detecting unit and a capacity holding rate calculated by the capacity holding rate calculating unit; and an estimating unit configured to estimate a condition of a residual quantity of the secondary battery based on the voltage detected by the voltage detecting unit after the waiting time calculated by the waiting time calculating unit elapses.

### Effect of the Invention

According to the embodiment of the present invention, it is possible to accurately estimate the condition of residual quantity of the secondary battery.

### BRIEF DESCRIPTION OF DRAWINGS

FIG. 1 illustrates a voltage stabilizing property of a lithium-ion battery.

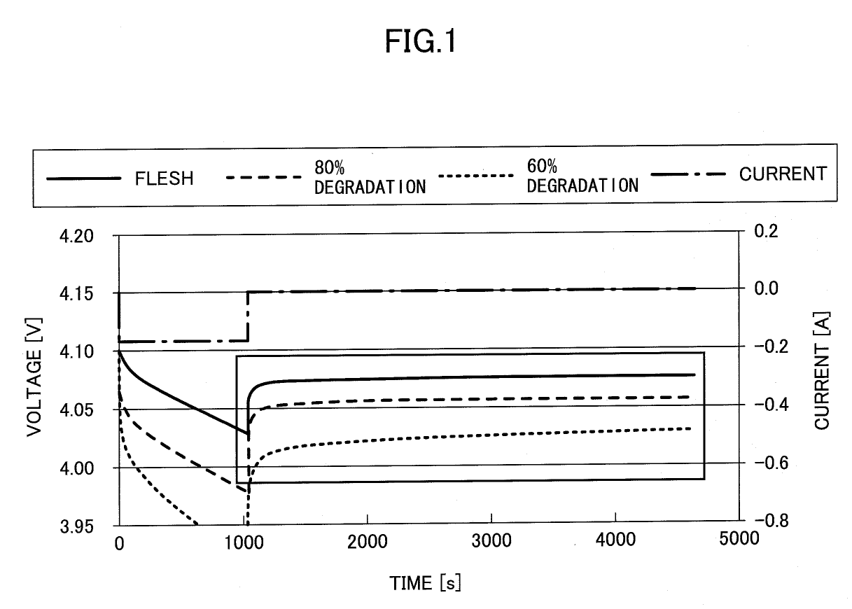

FIG. 2 illustrates an entire structure of a battery monitoring system 1 including a battery condition detecting apparatus 20 of an embodiment of the present invention.

FIG. 3 illustrates a voltage recovering property of a secondary battery 10 at a temperature of 25° C.

FIG. 4 illustrates a previously measured result of a stabilization waiting time T for the secondary battery 10 for each ambient temperature Ta and each capacity holding rate K.

FIG. 5 illustrates properties of coefficients α and β for the ambient temperature Ta.

FIG. 6 illustrates an operation flow of an operating part 24.

FIG. 7 illustrates a property of “open voltage-ambient temperature”.

FIG. 8 illustrates a property of “open voltage-charging rate” at a temperature of 25° C.

FIG. 9 is an enlarged view of a part of the property illustrated in FIG. 8.

### BEST MODE FOR CARRYING OUT THE INVENTION

A description is given below, with reference to the figures of the embodiments of the present invention.

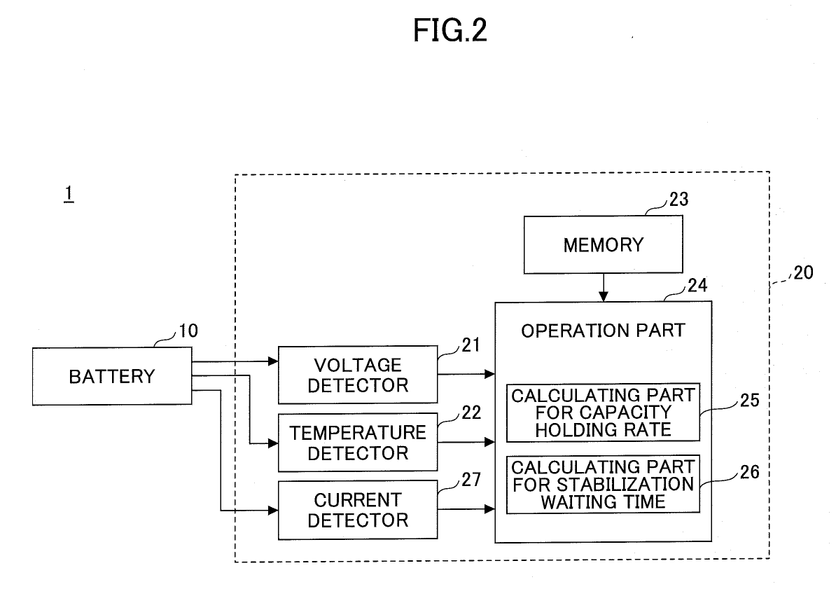

FIG. 2 illustrates an entire structure of a battery monitoring system 1 including a battery condition detecting apparatus 20 of an embodiment of the present invention. The battery monitoring system 1 includes a secondary battery 10 and a battery condition detecting apparatus 20 for detecting a condition of the secondary battery 10. An exemplary secondary battery 10 is a lithium-ion battery, a nickel-metal hydride battery, or the like. The battery condition detecting apparatus 20 includes a voltage detector 21, a temperature detector 22, a memory 23 and an operation part 24. The battery condition detecting apparatus 20 may include a current detector 27 for detecting a charging or discharging current (an input or output current) for the secondary battery 10. The components such as the voltage detector 21 of the battery condition detecting apparatus 20 may be formed by, for example, an integrated circuit.

The voltage detector 21 is a unit for detecting an output voltage from the secondary battery 10. The voltage detector 21 outputs detected data of the output voltage from the secondary battery 10 to the operation part 24. The voltage detector 21 detects the output voltage from the secondary battery 10 at least under a condition, in which the charging or discharging current (the input and output current) for the secondary battery 10 are a predetermined first threshold (for example, zero or a value slightly greater than zero) or smaller, as an open voltage of the secondary battery 10. The voltage detector 21 may detect an interpolar voltage measured between poles of a stabilized secondary battery 10 when the poles are electrically opened or connected with a high impedance. Further, the voltage detector 21 may detect the interpolar voltage measured between the poles of the secondary battery 10 connected to a load causing a standby current (e.g., 1 mA or smaller) to be supplied to an external device such as a mobile phone and a game machine, which is to be connected to a battery condition detecting apparatus 20, as the open voltage of the secondary battery 10.

The temperature detector 22 is a temperature detecting unit configured to detect an ambient temperature Ta of the secondary battery 10. The voltage detector 22 outputs detected data of the ambient temperature Ta to the operation part 24. The temperature detector 22 may detect the temperature of the secondary battery 10 as the ambient temperature Ta.

The operation part 24 is a unit configured to estimate a condition of residual quantity (especially, a charging rate) of the secondary battery 10 based on detected data of the voltage detected by the voltage detector 21, detected data of the temperature detected by the temperature detector 22, and a battery property inherent in the secondary battery 10 previously stored in the memory 23. An exemplary operation part 24 is a microcomputer in which a central processing unit or the like is integrated. An exemplary memory 23 for storing a property parameter for specifying the battery property of the secondary battery 10 is an EEPROM or a flash memory.

The operation part 24 includes a calculating part for a capacity holding rate 25 as a capacity holding rate calculating unit configured to calculate a capacity holding rate K of the secondary battery 10. A measure of calculating the capacity holding rate K may be arbitrarily selected from known methods.

The calculating part for the capacity holding rate 25 may calculate the capacity holding rate K of the secondary battery 10 at an arbitrary time point based on

K=RFCC/AFCC (1),

where AFCC represents an initial fully charged capacity (in a brand new state) and RFCC represents a fully charged capacity at an arbitrary time point.

Said differently, the capacity holding rate K can be expressed by a present fully charged capacity ratio relative to the initial fully charged capacity. The reason why the fully charged capacity gradually decreases from an initial state is aging degradation of the secondary battery 10.

Methods of calculating the fully charged capacity of the secondary battery 10 include, for example, a method of calculating the fully charged capacity based on the secondary battery 10 and a method of calculating the fully charged capacity based on an amount of charge. For example, in a case where the fully charged capacity of the secondary battery 10 is calculated based on the amount of charge controlled by a battery charger, a pulse charge or an ordinary charge using a constant voltage or a constant current is used. Therefore, an accurate charging current can be measured in comparison with a case where the fully charged capacity of the secondary battery 10 is calculated based on the amount of charge, which is susceptible to a consumption current property of an external device (not illustrated) using the secondary battery 10 as a power source 10. A selection of the method of calculating the fully charged capacity based on the secondary battery 10 or the method of calculating the fully charged capacity based on the amount of charge may be determined in consideration of a property of the external device or the like. Both or one of the method of calculating the fully charged capacity based on the secondary battery 10 and the method of calculating the fully charged capacity based on the amount of charge may be selected.

A condition for measuring an accurate fully charged capacity is a case where charging is continued for a period while the residual quantity of electric power is changed from zero to full. Current values accumulated during the period are the fully charged capacity. However, charging the secondary battery 10 from the residual quantity of zero to the residual quantity of full is scarcely carried out in an ordinary usage. Ordinarily, charging is started when there is a certain residual quantity.

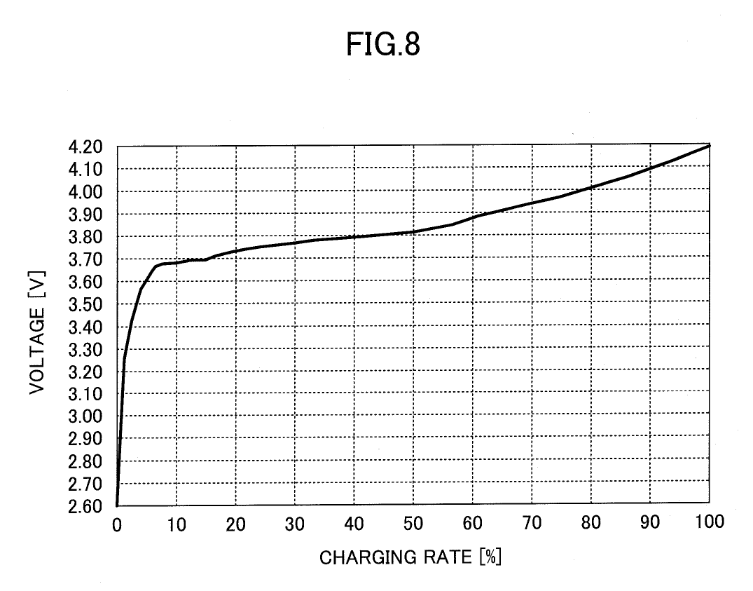

Therefore, the calculating part for the capacity holding rate 25 of the operation part 24 considers the case where charging is started when there is the certain residual quantity to thereby calculate the fully charged capacity of the secondary battery 10 based on a battery voltage immediately before starting charging, and a battery voltage at a predetermined elapsed time after ending charging. Said differently, the calculating part for the capacity holding rate 25 calculates the charging rate immediately before starting charging based on the battery voltage immediately before starting charging and the property of “open voltage-charging rate” (see FIG. 8). Further, the calculating part for the capacity holding rate 25 calculates the charging rate at the predetermined elapsed time after ending charging based on the battery voltage at the predetermined elapsed time after ending charging and the property of “open voltage-charging rate” (see FIG. 8). When the fully charged capacity of the secondary battery 10 is represented by 100, a rate of the residual quantity of the secondary battery 10 is expressed in percent figures as the charging rate. The property of “open voltage-charging rate” may be represented by a correction function or a correction function. Data inside the correction table and a coefficient of the correction function are stored in the memory 23 as the property data.

The operation part 24 calculates or corrects the charging rate in response to the open voltage measured by the voltage detector 21 based on the correction table and the correction function, in which the property data read out from the memory 23 are reflected.

Therefore, the calculating part for the capacity holding rate 25 calculates the fully charged capacity FCC of the secondary battery 10 at an arbitrary time based on

FCC=Q/{(SOC2−SOC1)/100} (2),

where FCC represents the fully charged capacity [mAh], SOC1 represents a charging rate [%] immediately before starting charging, SOC2 represents a charging rate [%] at the predetermined elapsed time after ending charging, and Q represents an electric charge charged during a charging period from the charging starting time point to the charging ending time point.

Although details of SOC1 and SOC2 will be described later, when SOC1 and SOC2 undergo a temperature correction, more accurate values may be calculated. It is possible to enhance an accuracy of calculation result by reflecting the battery voltage more stable than the battery voltage at the time of ending charging by using the battery voltage at the time point when the predetermined time elapses after the time point of ending charging. Further, the electric charge Q can be calculated by accumulating the charging or discharging current of the secondary battery 10. The operation part 24 can calculates the electric charge Q based on current detection data obtained by the current detector 27 which detects the charging or discharging current of the secondary battery 10.

As described, the calculating part for the capacity holding rate 25 can calculate a present capacity holding rate K by reflecting the initial fully charged capacity AFCC which is previously stored in the memory 23 and the present fully charged capacity RFCC which is calculated based on the computing equation (2) on the computing equation (1).

Further, the operation part 24 includes a calculation part for the stabilization waiting time 26 as a unit configured for calculate the stabilization waiting time T necessary for stabilizing the output voltage of the secondary battery 10. The voltage stabilization waiting time T starts when the discharging current (or the charging current) for the secondary battery 10 becomes a predetermined first threshold value (e.g., zero or a value slightly greater than zero) or smaller, and ends when the voltage variation of the secondary battery 10 per a unit time becomes a second predetermined value (e.g., zero or a value slightly greater than zero) or smaller. Said differently, the state of the stable voltage, in which the output voltage from the secondary battery 10 is stabilized, corresponds to a state in which the discharging current (or the charging current) of the secondary battery 10 continues for the stabilization waiting time T or longer. The calculation part for the stabilization waiting time 26 calculates the stabilization waiting time T for transitioning to the state of the stable voltage based on a battery property, which is peculiar to the secondary battery and indicative of a relationship between the ambient temperature Ta, the capacity holding rate K and the stabilization waiting time T. This calculation is in response to the measured value of the ambient temperature detected by the temperature detector 22 and the calculated value of the capacity holding rate K calculated by the calculating part for the capacity holding rate 25.

Next, a calculating method for calculating the stabilization waiting time T by the calculation part for the stabilization waiting time 26 is described in detail.

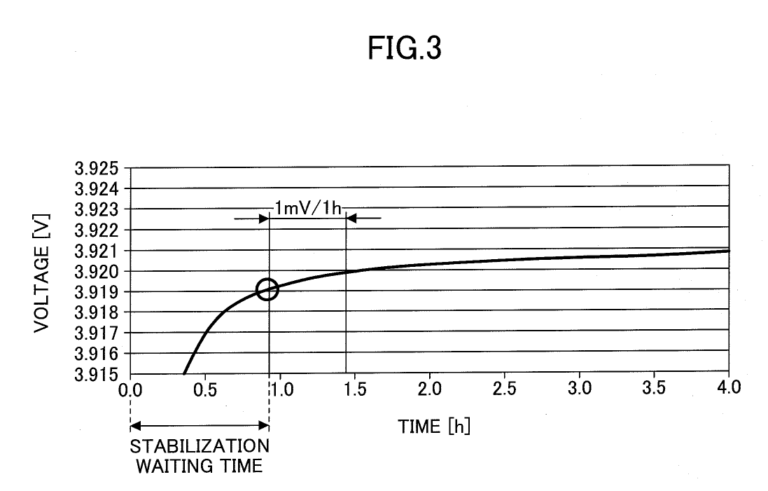

FIG. 3 illustrates a voltage recovering property of the secondary battery 10 at a temperature of 25° C.

Referring to FIG. 3, the output voltage dropped by a flow of the discharging current gradually rises due to a stop of the discharging current. The time point of stopping the discharging current corresponds to zero on the time axis. The stabilization waiting time T is defined as an elapsed time between a discharging stopping time point of the secondary battery 10 (i.e., a time point when the predetermined first threshold value is zero) and a time point when a variation of the open voltage of the secondary battery per a unit time reaches a second threshold value or smaller. FIG. 3 illustrates the stabilization waiting time T between the discharging stopping time point and a time point when the variation of the open voltage per one hour reaches 1 mV or smaller. It is preferable to measure the stabilization waiting time T by a timer (a time measuring unit) of the operation part 24.

The calculation part for the stabilization waiting time 26 calculates the stabilization waiting time T based on the battery property, which is inherent in the secondary battery and indicative of the relationship among the ambient temperature Ta, the capacity holding rate K and the stabilization waiting time T, in response to the measured value of the ambient temperature Ta and the calculated value of the capacity holding rate K. Therefore, it is necessary to previously measure the battery property inherent in the secondary battery 10 and store in the memory 23.

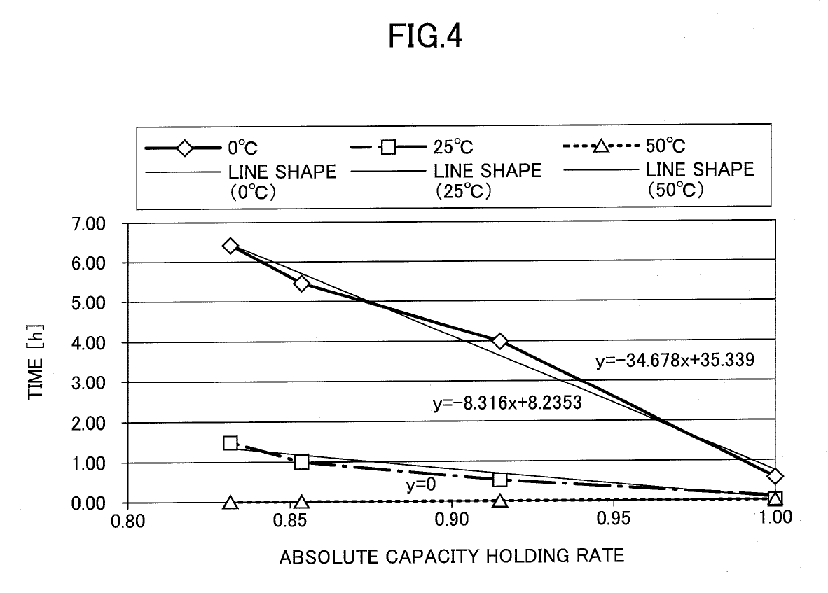

FIG. 4 illustrates previously measured results of the stabilization waiting time T of the secondary battery 10 for each ambient temperature Ta and each capacity holding rate K. Referring to FIG. 4, the stabilization waiting times T are measured with respect to each of the ambient temperatures of 0° C., 25° C., and 50° C. and each of the four capacity holding rates K. Referring to FIG. 4, the axis of ordinate represents the stabilization waiting time T and the axis of abscissas represents the capacity holding rate K. As known from the graph illustrated in FIG. 4, the stabilization waiting time I of the open voltage after discharge or before charging can be expressed by a linear function in which the capacity holding rate K is used as a variable.

Said differently, a property of the stabilization waiting time T relative to the capacity holding rate K is expressed by a linear function using coefficients α and β as follows:

T=α×K+β (3)

If the coefficients α and β are specified, it is possible to uniquely express the property of the stabilization waiting time T relative to the capacity holding rate K illustrated in FIG. 4 by the formula (3). Therefore, the coefficients α and β of formula (3) are calculated for each ambient temperature Ta by a curve fitting process (curve approximation). Specifically, the coefficients α and β of the formula (3) at a temperature of 0° C., the coefficients α and β of the formula (3) at a temperature of 25° C., and the coefficients α and β of the formula (3) at a temperature of 50° C. are calculated. Calculation results of the property illustrated in FIG. 4 are “α=−34.678 and β=35.339” at the temperature of 0° C., “α=−8.316 and β=8.2353” at the temperature of 25° C., and “α=β=0” at the temperature of 50° C. The curve fitting process used here is a mathematical method of obtaining a curve (a regression curve) to be fit in plural groups of numerical data. With this curve fitting process a model function is appropriately assumed. A parameter for determining the shape of the model function is statistically assumed. For example, in order to obtain the curve to be fit in plural groups of numerical data, a method of least squares may be used. In order to calculate the coefficients of the formula (3) by the curve fitting process, numeric solution software such as MATLAB and LabVIEW may be used.

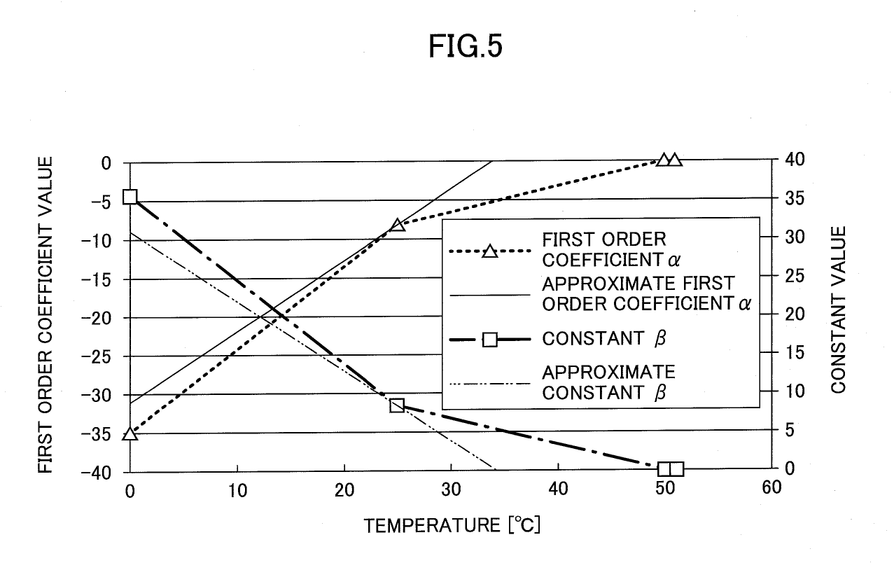

Next, a coefficient computing equation, by which the coefficients of the model linear function (3) can be calculated, is set up based on the ambient temperature Ta. By defining the coefficients α and β using the function of the ambient temperature Ta, it is possible to express plural linear functions (3) for the plural temperatures illustrated in FIG. 4 by a single approximate computing equation. In view of the operation result of the above curve fitting process, the coefficients α and β have properties illustrated in FIG. 5 corresponding to the ambient temperature Ta. By defining the coefficients α and β using a linear function of the ambient temperature Ta, a coefficient computing equation expressing a property of “coefficient-temperature” is:

coefficient=α×Ta+b (4)

Specifically, the coefficient is defined as follows.

α=α(Ta)=a2×Ta+b1 (4a)

β=β(Ta)=a2×Ta+b2 (4b)

By performing the curve fitting process in a manner similar to the above (i.e., the calculated ambient temperature Ta and data including groups of the coefficients α and β), it is possible to calculate approximate coefficients {a1, b1}, {a2, b2} of the coefficient computing equations (4a) and (4b).

Said differently, by substituting the calculated approximate coefficients for corresponding parts of the coefficient computing equations (4a) and (4b), the coefficient computing equation is determined. By substituting the determined coefficient computing equation for corresponding parts of the formula (3), the computing equation of the stabilization waiting time T using the ambient temperature Ta and the capacity holding rate K as variables.

Next, described is a flow in which the calculation part for the stabilization waiting time 26 calculates the stabilization waiting time T in conformity with the computing equation (3) of the stabilization waiting time T which is previously introduced as described above.

The calculation part for the stabilization waiting time 26 calculates the coefficients α and β corresponding to the ambient temperature Ta at the time point of the measurement by substituting the ambient temperature Ta, which are measured by the temperature detector 22, and the coefficients {a1, b1} and {a2, b2} of the coefficient equations (4a) and (4b), which are previously operated and stored in the memory 23, for the coefficient computing equations (4a) and (4b). Then, the calculation part for the stabilization waiting time 26 can calculate the stabilization waiting time T by substituting the capacity holding rate K, which is calculated by the calculating part for the capacity holding rate 25, and the coefficients α and β, calculated based on the coefficient computing equation (4a) and (4b), for the computing equation (3).

As described above, according to the above-described structure, since the ambient temperature Ta and the stabilization waiting time T related to the capacity holding rate K are calculated, it is possible to accurately calculate the stabilization waiting time T necessary for accurately detecting the condition of residual quantity of the secondary battery. For example, if the charging rate of the secondary battery 10 is calculated based on a battery condition such as an open voltage of the secondary battery 10 before the stabilization waiting time I elapses, an error may occur in calculating the charging rate, thereby degrading the accuracy of the entire battery monitoring system 1. However, with the above structure, the accuracy degradation caused by shortage of the stabilization waiting time can be suppressed. For example, if an excessive time is spent for waiting for a stabilized output voltage of the secondary battery 10, an opportunity of calculating the charging rate decreases and the accuracy of the entire system is lowered. However, with the above structure, it is possible to suppress the lowering of the accuracy.

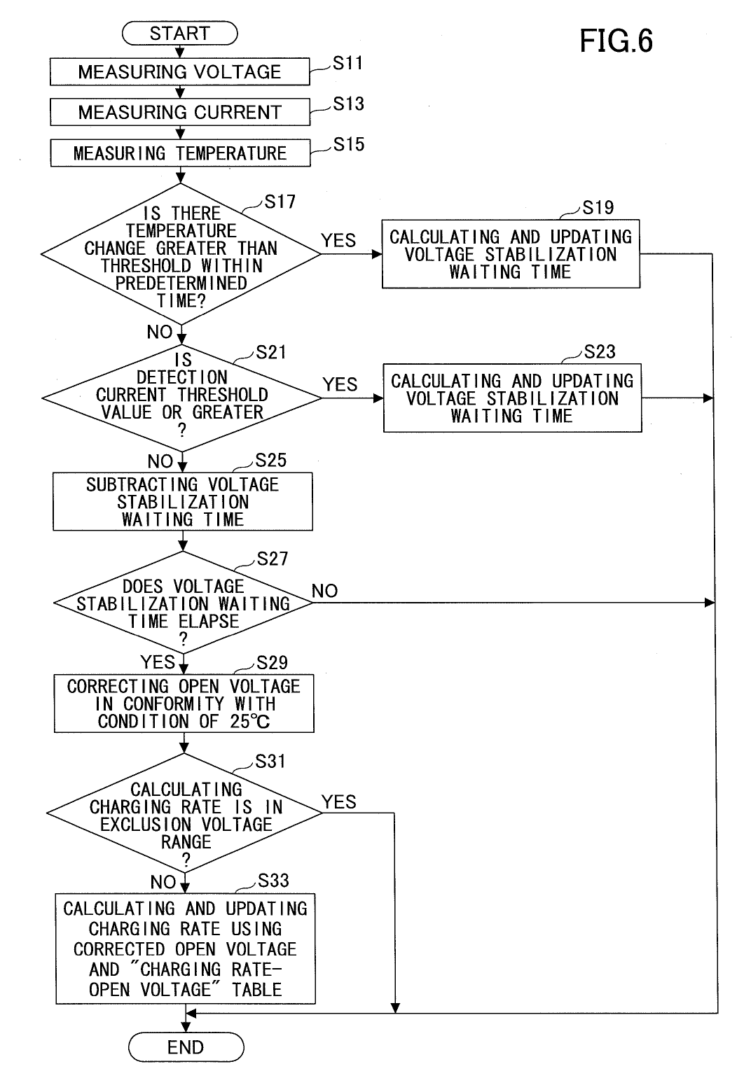

Referring to FIG. 6, the charging rate of the secondary battery 10 is calculated. The operation part 24 starts operations in conformity with the flow illustrated in FIG. 6, specifically when it is detected that a charging or discharging current for the secondary battery 10 is smaller than or equal to a predetermined first threshold value. The operation part 24 forcibly ends operations also in conformity with the flow illustrated in FIG. 6, that is when it is detected that a charging or discharging current for the secondary battery 10 is more than a predetermined first threshold value.

The operation part 24 measures the output voltage of the secondary battery 10 as the open voltage with the voltage detector 21 in step S11. The operation part 24 measures the charging or discharging current for the secondary battery 10 with the current detector 27 in step S13. The operation part 24 measures the ambient temperature of the secondary battery 10 with the temperature detector 22 in step S15. The order of step S11 to step S15 is not specifically limited to what is shown in FIG. 6.

In a case where at least one of the ambient temperature Ta of the secondary battery 10 and the charging or discharging current varies beyond predetermined reference values before the calculated stabilization waiting time T elapses, the calculation part for the stabilization waiting time 26 calculates the stabilization waiting time T again using a value changed in conformity with the variation and changes a register value of the stabilization waiting time T so as to be the calculation value, which is calculated again, in steps S17 to S23.

For example, in a case where the temperature exceeding the reference value is detected during a predetermined period, the stabilization waiting time T necessary after detecting the temperature is set again. Even though the variation of the ambient temperature of the secondary battery 10 is stabilized, there is a time lag until the temperature of the secondary battery 10 is stabilized. Therefore, battery conditions such as a measured open voltage and a battery temperature may not be stabilized. Therefore, by estimating a condition of the residual quantity of the secondary battery 10 based on the battery condition such as the ambient temperature Ta and the ambient temperature Ta before the variation of the charging or discharging current, an estimated error may increase. However, by prolonging the stabilization waiting time T as in steps S17 to S23, it is possible to prevent the estimated error from increasing. As described, by prolonging the stabilization waiting time T in the case where the temperature change or the like is detected, it is possible to measure the battery condition such as the further accurate open voltage and the ambient temperature. Thus, it is possible to delay a timing of calculating the charging rate described later and to improve the accuracy of the calculated charging rate.

For example, in step S17, in a case where a variation of the ambient temperature Ta exceeding the reference value is detected during the predetermined time after detecting the charging of discharging current for the secondary battery 10 having the predetermined threshold value or smaller, the calculation part for the stabilization waiting time 26 calculates the stabilization waiting time T corresponding to the capacity holding rate K, which has already been calculated, and the ambient temperature T, obtained after the variation, and updates by changing the register value to the calculation value calculated again in step S19.

Further, for example, in step S21, the calculation part for the stabilization waiting time 26 calculates the stabilization waiting times T corresponding to the ambient temperature K, which has already been measured, and to the capacity holding rate K after the variation again, and updates by changing the register value to the calculation value calculated again in step S23. This is because a flow of the charging or discharging current having the predetermined threshold value or greater is a condition for calculating the stabilization waiting time T again and may cause the variation of the capacity holding rate K.

The operation part 24 subtracts a predetermined value from the register value of the stabilization waiting time T in a case where both of the ambient temperature Ta of the secondary battery 10 and the charging or discharging current do not exceed the predetermined reference values in steps S17 and S21 (e.g., variations within predetermined ranges) in step S25. Then, the operation part 24 determines whether the stabilization waiting time T elapses, said differently whether the register value of the stabilization waiting time T becomes zero in step S27. If the stabilization waiting time T does not elapse, the process returns to START of this flowchart.

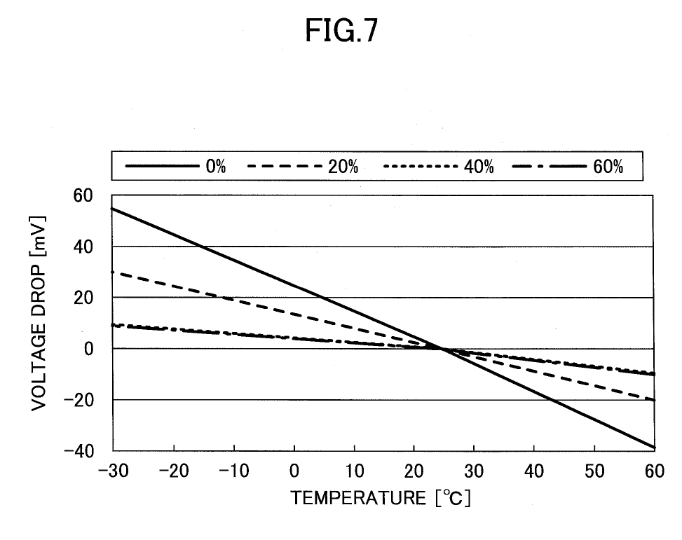

If the stabilization waiting time T elapses, the operation part 24 corrects the open voltage measured under the stable voltage after the stabilization waiting time T (or the open voltage measured in step S11) so as to conform to a condition of 25° C. based on the property data indicative of the property of “open voltage-ambient temperature” (see FIG. 7), previously stored in the memory 23, and in response to the ambient temperature measured under the stable voltage after the stabilization waiting time T (or the ambient temperature measured in step S15) in step S29. The property of “open voltage-ambient temperature” (FIG. 7) illustrates an offset value of the open voltage at various temperatures including 25° C. FIG. 7 illustrates offset amounts of the open voltage for each charging rate of the secondary battery 10.

The operation part 24 determines whether the open voltage corrected in conformity with the condition of 25° C. in step S29 belongs to a charging or discharging exclusion voltage range in step S31. If the open voltage does not belong to the charging or discharging exclusion voltage range, the charging rate corresponding to the open voltage corrected in the condition of 25° C. in step S29 is calculated as the condition of the residual quantity of the secondary battery 10 based on the property data indicative of the property of “open voltage-ambient temperature” (FIG. 8), stored in the memory 23. Then, the register value of the charging rate is updated so as to be changed to calculated value in step 533. If the open voltage belongs to the charging or discharging exclusion voltage range, the charging rate is not calculated and the register value of the charging rate is maintained as is.

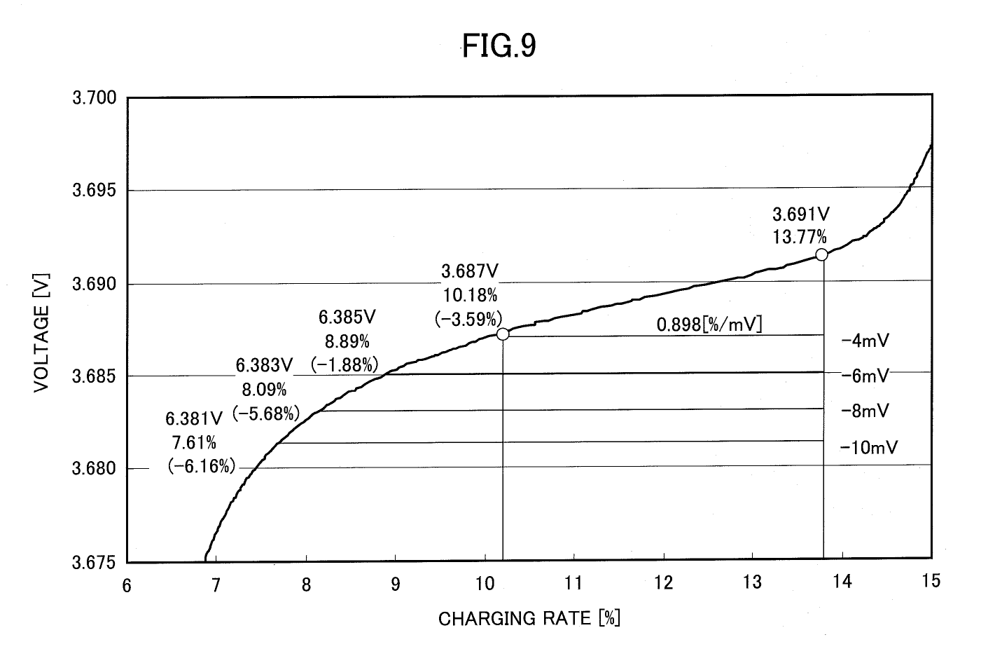

Next, the charging or discharging exclusion voltage range is described. FIG. 9 is an enlarged view of a part of a voltage range illustrated in FIG. 8, which the open voltage of the secondary battery 10 may take. Referring to FIG. 8 and FIG. 9, a gradient of the graph at around an open voltage of 3.7 V is very small and about 0.9%/1 mV. Therefore, it is known that this area at around the open voltage of 3.7 V is very susceptible to influence of scattering in the measured voltage. Therefore, if the charging rate is calculated based on the open voltage within the voltage range susceptible to influence of an error of the measured voltage, an error of the calculated value also increases. Therefore, by limiting the voltage range of the open voltage used in calculating the charging rate to a voltage region excluding the voltage region in which the charging rate per a unit open voltage by a predetermined value or greater, it is possible to prevent the calculation error of the charging rate from increasing.

Although the invention has been described with respect to specific embodiments for a complete and clear disclosure, the appended claims are not to be thus limited but are to be construed as embodying all modifications and alternative constructions that may occur to one skilled in the art that fairly fall within the basic teachings herein set forth.

For example, within the above embodiment, the formula (4) is set as the coefficient computing equation indicative of the property of “coefficient-temperature” by defining the coefficients α and β illustrated in FIG. 5 as liner functions of the ambient temperature Ta. However, it is also possible to define the coefficients α and β illustrated in FIG. 5 as a quadratic functions of the ambient temperature Ta and determine a coefficient computing equation indicative of the property of “coefficient-temperature” as follows:

coefficient=c×Ta2+d×Ta+e (5)

For example,

α=α(Ta)−c1×Ta2+d1×Ta+e1 (5a)

β=β(Ta)=c2×Ta2+d2×Ta+e2 (5b)

In this case, the memory 23 previously stores coefficients {c1, d1, e1}, {c2, d2, e2} of the coefficient computing equations (5a) and (5b). Therefore, a calculation accuracy of the stabilization waiting time T is further improved, an estimation accuracy of the condition of the residual quantity of the secondary battery 10 also improves.

The international application is based on Japanese Priority Patent Application No. 2010-035401 filed on Feb. 19, 2010, the entire contents of Japanese Priority Patent Application No. 2010-035401 are hereby incorporated herein by reference.

### EXPLANATION OF REFERENCE SIGNS

1: battery monitoring system
10: secondary battery
20: battery condition detecting apparatus
21: voltage detector
22: temperature detector
23: memory
24: operation part
25: calculating part for the capacity holding rate
26: calculation part for stabilization waiting time
27: current detector

1. A battery condition detecting apparatus comprising:
a temperature detecting unit configured to detect a temperature of a secondary battery;
a capacity holding rate calculating unit configured to calculate a capacity holding rate of the secondary battery;
a voltage detecting unit configured to detect a voltage of the secondary battery;
a waiting time calculating unit configured to calculate a waiting time between a time point when
a current of the secondary battery becomes a predetermined current value or smaller and
a time point when a voltage variation of the secondary battery per a unit time based on a battery property of the secondary battery indicative of a relationship among a temperature of the secondary battery, a capacity holding rate of the secondary battery, and the waiting time in response to the temperature detected by the temperature detecting unit and a capacity holding rate calculated by the capacity holding rate calculating unit; and
an estimating unit configured to estimate a condition of a residual quantity of the secondary battery based on the voltage detected by the voltage detecting unit after the waiting time calculated by the waiting time calculating unit elapses.

2. The battery condition detecting apparatus according to claim 1,
wherein the waiting time calculating unit calculates the waiting time again in a case where at least one of the temperature of the secondary battery and the current varies to exceed a predetermined standard before the waiting time elapses, and
wherein the estimating unit estimates the condition of the residual quantity after the waiting time calculated again elapses.

3. The battery condition detecting apparatus according to claim 1,
wherein the battery property is expressed by an arithmetic expression of T=α×K+β, where T represents the waiting time, K represents the capacity holding rate of the secondary battery, and α and β represent coefficients changeable in response to the temperature of the secondary battery.

4. The battery condition detecting apparatus according to claim 3, further comprising:
a storage unit configured to store property data for specifying the coefficients α and β.

5. The battery condition detecting apparatus according to claim 4,
wherein the property data are coefficient data of a function with which the coefficients α and β are derived using the temperature of the secondary battery as a variable.

6. The battery condition detecting apparatus according to claim 1,
wherein the estimating unit estimates the condition of the residual quantity based on a voltage, in which a charging rate per a unit voltage changes to be a predetermined value or greater, outside a voltage region available by the secondary battery in a correlation property between the voltage of the secondary battery and the charging rate.

7. A battery condition detecting method comprising:
calculating a waiting time between a time point when a current of a secondary battery becomes a predetermined current value or smaller and a time point when a voltage variation of the secondary battery per a unit time based on a battery property of the secondary battery indicative of a relationship among a temperature of the secondary battery, a capacity holding rate of the secondary battery, and the waiting time in response to the detected temperature and the calculated capacity holding rate; and
calculating a condition of a residual quantity of the secondary battery based on an open voltage measured after the calculated waiting time.

8. The battery condition detecting method according to claim 7, further comprising:
calculating the waiting time again in a case where at least one of the temperature of the secondary battery and the current varies to exceed a predetermined standard before the waiting time elapses; and
estimating the condition of the residual quantity of the secondary battery after the waiting time calculated again elapses.

9. The battery condition detecting method according to claim 7,
wherein the battery property is expressed by an arithmetic expression of T=α×K+β, where T represents the waiting time, K represents the capacity holding rate of the secondary battery, and α and β represent coefficients changeable in response to the temperature of the secondary battery.

10. The battery condition detecting method according to claim 9, further comprising:
storing property data for specifying the coefficients α and β.

11. The battery condition detecting method according to claim 10,
wherein the property data are coefficient data of a function with which the coefficients α and β are derived using the temperature of the secondary battery as a variable.

12. The battery condition detecting method according to claim 7, further comprising:
estimating the condition of the residual quantity based on a voltage, in which a charging rate per a unit voltage changes to be a predetermined value or greater, outside a voltage region available by the secondary battery in a correlation property between the voltage of the secondary battery and the charging rate.
